(19) United States
(12) Patent Application Publication
(10) Pub. No.: US 2009/0089115 A1
(43) Pub. Date: Apr. 2, 2009

(54) Computer-implemented methods and systems for deriving process flow diagrams

(75) Inventor: Ravy Murthy, Fremont, CA (US)

Correspondence Address: YOUNG LAW FIRM, P.C.;ALAN W. YOUNG, 4370 ALPINE ROAD, SUITE 106, PORTOLA VALLEY, CA, 94028, US

(73) Assignee: Oracle International Corporation, Redwood Shores, CA (US)

(21) Appl. No.: 11/865,487

(22) Filed: Oct. 1, 2007

(51) Int. Cl. G06Q 10/00; G06F 17/00

(52) U.S. Cl. 705/7

(57) ABSTRACT

A computer-implemented method of deriving a process flow diagram may include defining a computer-implemented business process, the business process including a plurality of computer-implemented operations, each of the plurality of operations including a condition precedent that must be satisfied for the activity to be executed. The defined computer-implemented process may be carried out over a selectable period of time, each time executing selected ones of the plurality of operations, depending on which of the condition precedents are satisfied and data may be collected on the executed selected ones of the operations upon execution thereof. A process flow diagram may then be derived from the collected data, the derived process flow diagram representing an historical view of the executed selected ones of the plurality of operations of the defined computer-implemented process. The derived process flow diagram may then be rendered.

### BACKGROUND OF THE INVENTION

Embodiments of the present invention relate to computer-implemented methods and systems for deriving process flow diagrams. Process flow diagrams are graphical representations of business process flows, where each constituent operation of the business process corresponds to a node of the diagram and where he flow between the constituent operations of the business process are represented by the connections between the nodes of the diagram.

### SUMMARY OF THE INVENTION

According to an embodiment thereof, the present invention is a computer-implemented method for deriving a process flow diagram. The method may include steps of defining a computer-implemented business process, the business process including a plurality of computer-implemented operations, each of the plurality of operations including a condition precedent that must be satisfied for the activity to be executed; repeatedly carrying out the defined computer-implemented process over a selectable period of time, each time executing selected ones of the plurality of operations, depending on which of the condition precedents are satisfied; collecting data on the executed selected ones of the operations upon execution thereof; deriving the process flow diagram from the collected data, the derived process flow diagram representing an historical view of the executed selected ones of the plurality of operations of the defined computer-implemented process, and rendering the derived process flow diagram.

The collecting step may be carried out over a first predetermined period of time and the deriving step may be carried out from the data collected during the predetermined period of time. The collecting step may be carried out over a second predetermined period of time that is longer than the first predetermined period of time, and the deriving step may include a step of modifying the process flow diagram derived from the statistics collected during the first predetermined time period to reflect the data collected over the second predetermined period of time. A step may be carried out of generating an ordered list of the executed selected ones of the plurality of operations each time the computer-implemented process is carried out and the data collecting step may be carried out on the generated ordered list generated for each iteration. The data collecting step may collect data indicative of the time elapsed between execution of the previously executed selected activity and execution of a next executed selected activity and the deriving and rendering step may be carried out such that the process flow diagram includes indicia indicative of the elapsed time. The data collecting step may include collecting data indicative of whether any two or more of the executed selected operations executed at least partially concurrently and the deriving and rendering steps may be carried out such that the process flow diagram indicates any concurrency of execution of the executed selected operations. The statistics collecting step may include a step of collecting data that includes an identification of each of the executed selected operations and the deriving and rendering steps may be carried out such that the process flow diagram includes indicia of the identification of one or more executed selected operation. The generating step may include generating a node in the process flow diagram for each of the executed selected operations. The generating step may include joining the generated nodes with a directed arc that indicates an order of execution of the executed selected operations corresponding to the generated nodes. A step may be carried out of providing a user interface to enable a user to manipulate the rendered process flow diagram according to what data was collected in the collecting step. The deriving and rendering steps may be carried out such that the process flow diagram includes probability indicia indicative of a frequency of traversal of at least selected portions of the process flow diagram. The providing step may be carried out such that the user interface provides a user with the ability to render the process flow diagram dynamically over the first predetermined period of time. The providing step may be carried out such that the user interface provides the user with video-like controls to control the rate at which the process flow diagram renders the collected data. The deriving and rendering steps may be carried out such that the process flow diagram includes indicia indicative of the role of the person or entity that executed one or more iterations of the computer-implemented process. The method may further include assigning a weight to a predetermined execution of the computer-implemented process and the deriving and rendering steps may be carried out such that the process flow diagram includes indicia indicative of the assigned weight. The deriving and rendering steps may be carried out such that the process flow diagrams includes an identification of any executed selected ones of the plurality of operations that are determined to be statistical AND nodes. The deriving and rendering steps may be carried out such that the process flow diagrams includes an identification of any executed selected ones of the plurality of operations that are determined to be statistical OR nodes.

According to another embodiment thereof, the present invention is a computer system for deriving a process flow diagram. The computer system may include at least one processor; at least one data storage device coupled to the at least one processor; a plurality of processes spawned by said at least one processor, the processes including processing logic for: defining a computer-implemented business process, the business process including a plurality of computer-implemented operations, each of the plurality of operations including a condition precedent that must be satisfied for the activity to be executed; repeatedly carrying out the defined computer-implemented process over a selectable period of time, each time executing selected ones of the plurality of operations, depending on which of the condition precedents are satisfied; collecting data on the executed selected ones of the operations upon execution thereof; deriving the process flow diagram from the collected data, the derived process flow diagram representing an historical view of the executed selected ones of the plurality of operations of the defined computer-implemented process, and rendering the derived process flow diagram.

According to still another embodiment, the present invention is a machine-readable medium having data stored thereon representing sequences of instructions which, when executed by a computing device, causes the computing device to derive a process flow diagram, by performing the steps of: defining a computer-implemented business process, the business process including a plurality of computer-implemented operations, each of the plurality of operations including a condition precedent that must be satisfied for the activity to be executed; repeatedly carrying out the defined computer-implemented process over a selectable period of time, each time executing selected ones of the plurality of operations, depending on which of the condition precedents are satisfied; collecting data on the executed selected ones of the operations upon execution thereof, deriving the process flow diagram from the collected data, the derived process flow diagram representing an historical view of the executed selected ones of the plurality of operations of the defined computer-implemented process, and rendering the derived process flow diagram.

### BRIEF DESCRIPTION OF THE DRAWINGS

FIG. 1 shows the constituent operation of a simple business process.

FIG. 2 shows a process flow diagram of the business process shown in FIG. 1.

FIG. 3 shows an alternative process flow diagram of the business process shown in FIG. 1.

FIG. 4 shows an aggregation of historical data collected at runtime for a predetermined business process, as well as a table of operations for such historical data, according to an embodiment of the present invention.

FIG. 5 shows a process flow diagram generated from the historical data in the table of operations of FIG. 4, according to an embodiment of the present invention.

FIG. 6 shows an aggregation of historical data collected at runtime for another iteration of business process P, as well as a table of operations for such historical data, according to another embodiment of the present invention.

FIG. 7 shows a process flow diagram generated from the historical data in the table of operations of FIG. 6, according to another embodiment of the present invention.

FIG. 8 shows a process flow diagram generated from the historical data in the table of operations of FIG. 6, according to yet another embodiment of the present invention.

FIG. 9 shows a process flow diagram generated from the historical data in the table of operations of FIG. 6, according to a still further embodiment of the present invention.

FIG. 10 shows a process flow diagram generated from the historical data in the table of operations of FIG. 6, according to still another embodiment of the present invention.

FIG. 11 shows a process flow diagram generated from the historical data in the table of operations of FIG. 6, according to yet another embodiment of the present invention.

FIG. 12 shows a process flow diagram generated from the historical data in the table of operations of FIG. 6, according to a still further embodiment of the present invention.

FIG. 13 shows a process flow diagram generated from the historical data in the table of operations of FIG. 6, according to still another embodiment of the present invention.

FIG. 14 shows an aggregation of historical data collected at runtime for a predetermined business process, as well as a table of operations for such historical data, according to an embodiment of the present invention.

FIG. 15 shows a process flow diagram generated from the historical data in the table of operations of FIG. 14, according to an embodiment of the present invention.

FIG. 16 shows an aggregation of historical data collected at runtime for another predetermined business process, as well as a table of operations for such historical data, according to an embodiment of the present invention.

FIG. 17 shows a process flow diagram generated from the historical data in the table of operations of FIG. 16, according to an embodiment of the present invention.

FIG. 18 shows a process flow diagram generated from the historical data in the table of operations of FIG. 16, according to another embodiment of the present invention.

FIG. 19 shows another process flow diagram generated from historical data, according to another embodiment of the present invention.

FIG. 20 shows an exemplary user interface for generating a process flow diagram, according to a further embodiment of the present invention.

FIG. 21 is a flowchart of an embodiment of a computer-implemented method for deriving a process flow diagram, according to an embodiment of the present invention.

FIG. 22 is a block diagram of a computer suitable for implementing embodiments of the present invention.

### DETAILED DESCRIPTION

Business processes may be composed of a plurality of operations, each carrying out a portion of the business process. A business process, therefore, may be modeled as a plurality of interconnected constituent operations. The interconnectedness of the constituent operations defines how and when these operations interact to achieve the goal of the underlying business process. For example, some of the constituent operations may require execution at specific times or under upon the occurrence of a specific event, while the execution of other operations may be dependent upon the prior execution and/or completion of one or more other constituent operations.

Software tools exist to generate diagrams of such business processes. Such software tools may be used to define the underlying business process flow, and each of the diagramed operations may correspond to one or more business processes being developed. In a diagram of such a business process flow, each operation corresponds to a node of the diagram and the connections between operations represent the flow between constituent nodes. These process flow diagrams are typically are generated a priori; that is, as the business flow itself is fully characterized before it is carried out. As such, process flow diagramming tools may also be considered as authoring tools to define and validate a business process flow.

FIG. 1 shows an example of a simple business process flow. In this case, for submitting an order. As shown, the “Submit Order” business process may include five constituent operations; namely, 1. Take or Receive an Order; 2. Validate the Order; 3. Bill the Order; 4. Ship the Order and 5. Close the Order. FIG. 2 shows one possible business process flow diagram 200 that is representative of the flow of the “Submit Order” business process flow. As shown therein, the diagram 200 may be defined to be wholly linear in nature, meaning that operation 1 is carried out first, followed consecutively by operations 2-5, as indicated by the “Time” arrow. In this business process flow diagram, each operation except operation 1 is dependent upon the successful completion of its predecessor operation. That is, operation 3 (Bill the Order) must be completed (or at least initiated) before operation 5 (Close the Order) may be carried out.

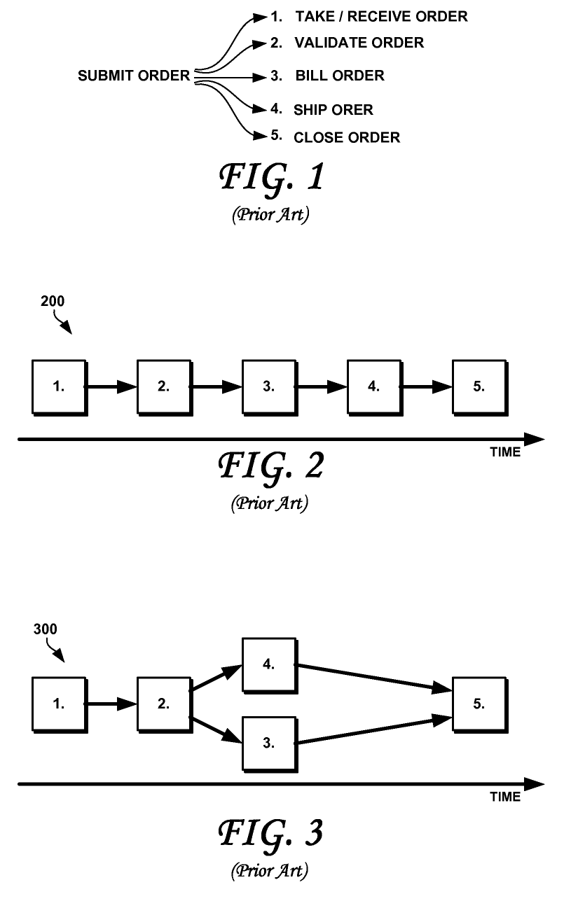

Alternatively, the “Submit Order” business process flow may be defined as shown in the business process flow diagram 300 of FIG. 3. Therein, it may be seen that the business process flow has been defined such that operations 3 and 4 must be carried out at the same time, initiated at the same time (or substantially the same time) or carried out at least partially concurrently. That is, the billing and shipping of the order are defined to be carried out at least partially concurrently. Operation 5 may be configured such that both operations 3 and 4 must have been completed for operation 5 to execute. As such, operation 5 may be configured as a Boolean AND gate, in which both of its inputs (operations 3 and 4) must have been completed for operation 5 to successfully complete.

Such business process flows are typically defined and diagramed before the real world business processes modeled by the business process flow occurs. In the example being developed herein, the “Submit Order” business process flow has been defined before actual orders are submitted, and rigidly defines the manner in which the underlying business process is executed; that is, the manner in which orders are submitted. As such, conventional business process flows and business process flow diagrams are inflexible, in that the constituent operations of the underlying business flow must always be carried out in the prescribed manner (e.g., operation 1 first, followed by operations 2, followed by operations 3, 4 and 5, as shown in FIGS. 1-3).

Services provided over the Internet, commonly referred to as web services or application services, are now in widespread use, as are technologies that facilitate such services. A web service may be defined as any information source running business logic processes that is configured for remote use by an application or end-user. Web services provide interoperability between various software applications running on disparate platforms, as they are, for the most part, based upon open standards and protocols. Protocols and data formats are text-based where possible, making it easy for developers to understand, making web services the preferred means through which functionality is exposed and accessed over computer networks such as the Internet. Web services typically include some combination of programming and data that are made available from an application server for end users and other network-connected application programs. Web services range from such services as storage management and customer relationship management down to much more limited services and functionality such as the submission of an order, as described above. Business process flows may be represented syntactically in languages such as XML (eXtendible Markup Language) and BPEL (Business Processes Execution Language), among others. In particular, Business Process Execution Language for web services (BPEL4WS) is a language used for the definition, testing and execution of business processes using web services. BPEL enables the top-down realization of Service Oriented Architecture (SOA) through composition, orchestration, and coordination of web services. BPEL provides a relatively easy and straightforward way to decompose a business process to be carried out over the Web into a plurality of constituent web service operations.

Accordingly, defining and representing business processes may follow a first model in which the business flow (as with BPEL, for example) is modeled a priori in such a manner that all defined processes are forced to follow a predefined execution path; namely, from one node to the next. However, business processes may be modeled according to a second model that involves the use of continuous queries or event definitions. In such a second model, there is no a priori flow defined—that is, the precise flow or order of execution of the constituent operations of the underlying business flow is not specified beforehand. Instead, a continuous query or event definition declares the conditions under which a particular operation is triggered and executed. Therefore, the actual flow of a given business process from one constituent operation to a next constituent operation of a given business process is determined dynamically, and may be wholly based on which conditions become true and/or which event occur during the execution of the business process. That is, a given business process may execute in a number of different manners, depending upon the conditions prevailing and/or events occurring at run time. While simple business flows such as outlined in FIGS. 1-3 may only have a limited number of ways to execute, real world business process flows typically have a much higher number of operations and have the potential of executing in correspondingly more complex ways. Therefore, it may be appreciated that diagramming the flow of a business process is difficult when the second model is used, precisely because the connections between the nodes (the constituent operations) of the diagram are not pre-defined—making the modeled business flow difficult to represent pictorially in any meaningful manner.

While the second model (using continuous queries or event definitions) is more flexible than the first model (using predetermined flow of operations determined a priori) i.e., allows for higher level of dynamic flows, it is still often very useful to represent the flow in a graphical manner; that is, to represent the flow diagram post-priori, to represent the constituent nodes and interconnections (also called edges) after-the-fact. Also, given a particular state of the process, it would be very useful to have the ability to identify and represent the next nodes and edges, at least probabilistically. That is, given any current state of a business process, it would be useful to be able to determine and to show which of the constituent operations of the modeled business process is to be or are to be executed next. If it is not possible to point to the next operation or operations with precision, it would be useful to have the ability to make a fact-based prediction as to which of the constituent operations of the business process is or are likely to be next executed. Currently, no solutions exist that addresses this problem.

According to an embodiment of the present invention, business processes may be modeled according to the second model in which the edges between the constituent operations of the business process are not defined a priori—that is, the flow between the constituent operations are not predetermined beforehand. Instead, a continuous query or event definition declares the condition or conditions under which a particular operation may be triggered and executed. For example, after execution of an operation labeled #2, a first event occurring at runtime may cause the execution of operation #3, whereas a second runtime event may cause operation #4 to execute. Therefore, after operation #2 has executed, the first event may be termed a condition precedent for the execution of operation #3 and the second event may be termed a condition precedent for the execution of operation #4. In such a model, part of the time, operation #3 may be after operation #2 (if the first event occurred after the execution of operation #2) and part of the time, execution of operation #4 may follow the execution of operation #2 (if the second event occurred after the execution of operation #2). Therefore, the actual flow of a given business process from one constituent operation to a next constituent operation may be determined dynamically, and is wholly based on which conditions become true and/or which events occur during the execution of the business process.

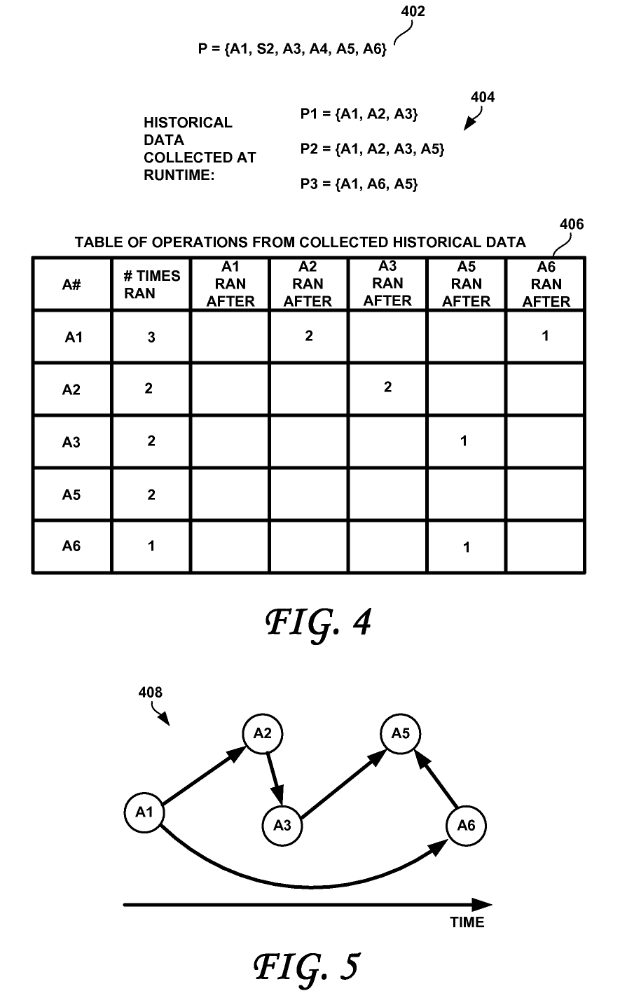

Which of the constituent operations execute at runtime, therefore, may be different from one execution of the business process to the next execution of the same business process. According to an embodiment of the present invention, data may be collected on which of the constituent operations of a predefined business process executed with each execution of the business process. That is, data may be collected at runtime and statistics may be compiled at runtime or thereafter that detail at least which of the constituent operations of the predefined business process executed, and in what order. Therefore, for each iteration of the business process (i.e., each time the business process is run), a record of which of the constituent operations of the business process executed and in what order may be generated at runtime, collected and compiled. In the aggregate, such collected data constitutes an historical record of the execution of the business process, and details the step-by-step execution flow of the process through the executed ones of the constituent operations thereof. FIG. 4 shows a simplified collection of historical data collected at runtime for an exemplary and illustrative business process, as well as a table of operations for such historical data, according to an embodiment of the present invention. In this example and as shown at 402, a simple business process P is composed of six constituent operations; namely, A1, A2, A3, A4, A5 and A6. When business process P executes, each of the constituent operations may execute in order (i.e., A1, followed by A2, followed by A3, etc.), or selected ones of the constituent operations may execute in an order that is determined by the prevailing conditions and/or event occurring at runtime. FIG. 4 shows an exemplary historical record of three iterations of process P, and details the selected constituent operations that executed in each iteration of the execution of process P and the order in which the selected constituent operations executed. As shown in FIG. 4, historical data 404 was collected for three instances of execution of business process P; namely, instances P1, P2 and P3. In instance P1, selected constituent operations A1, A2 and A3 were sequentially executed. In instance P2, selected constituent operations A1, A2, A3 and A5 were sequentially executed. Lastly, in instance P3, selected constituent operations A1, A6 and A5 were sequentially executed. As the sequence of operation was different in each iteration of business process P, it is reasonable to assume that different conditions prevailed in each of these iterations, thereby causing different ones of the constituent operations to be selected for execution.

FIG. 4 also shows a table of operations that details, in tabular form, the collected historical data of the three different iterations of business process P. The table 406 details the number of times each of the selected constituent operations ran and shows which the predecessor operation of each of the selected constituent operations. As shown, operation A1 ran three times, one in each of the iterations P1, P2 and P3 of the business process P. Operation A2 ran twice, A3 ran twice, A5 ran twice times and selected operation A6 executed only once in the three iterations of business process P. To generate this data, a counter may be provided for each of the operations A1, A2, A3, A4, A5 and A6 and these counters may be updated each time one of the operations executes. Also, the predecessor operation for each executing operation may be tracked. Other ways of generating and collecting this data may be devised, as those of skill in this art will recognize. The table of operations 406 of FIG. 4 also shows that A1 was the predecessor operation to operation A2 twice in the three iterations P1, P2 and P3. Also in the first row, the table 406 shows that A1 was the predecessor operation to operation A6 once in the three iterations of the business process P. Stated another way, A2 ran after A1 twice, and A6 ran after A1 once. The table also shows that A3 ran after A2 twice, A5 ran after A3 once, and A5 ran after A6 one time. For convenience, the zeros are not shown in the table of operations. That is, the table does not show, but may be understood to implicitly include, a zero in each of the blank cells. For example, operation A1 did not have any predecessor operations, as operation A1 was the first operation to be selected and executed in each of the three iterations of the business process P. Likewise, operation A6 was never executed after operation A5 in any of the iterations of P. Therefore, although not shown in FIG. 4, a zero may be understood to be implicitly at the intersection of the A5 row and A6 column, although not shown in FIG. 4. Similarly, the table of operations does not show either a row or a column for operation A4, as such constituent operation A4 was never selected for execution during any of the iteration of business process P. From this, it may be inferred that the conditions prevailing at the time of the execution of the P1, P2 and P3 did not favor selection and execution of constituent operation A4.

According to an embodiment of the present invention, a process flow diagram may be derived, generated and rendered from the collected historical data or statistics represented in the table of operations 406 of FIG. 4. As shown in FIG. 5, the process flow diagram may be (but need not) be represented as a series of interconnected nodes. As shown in FIG. 5, the process flow diagram 408 may include five nodes representing the selected constituent operations A1, A2, A3, A5 and A6 that are represented in the table of operations of FIG. 4. As shown in FIG. 5, the process flow diagram 408 may be configured to show the predecessor operations for each of the selected constituent operations. As shown by the directed arcs interconnecting the selected constituent operations A1, A2, A3, A5 and A6, operation A2's predecessor operation was A1, operation A3's predecessor operation was A2, operation A5 predecessor operations included both operations A3 and A6, and operation A6's predecessor operation was A1. Stated differently, during the three iterations of business process P 112, none of the operations preceded A1 and none followed A5, and operation A2 followed A1, A3 followed A2, A5 followed both A3 and A6 and A6 followed selected constituent operation A1. The Time arrow in FIG. 5 shows the direction of time, so that the temporal relationship of the executions of the selected constituent operations may be determined from examination of the process flow diagram.

Note that the process flow diagram 408 of FIG. 5 was generated not a priori (that is, before the business process P was repeatedly executed), but instead was generated and rendered from collected and compiled historical data and thus represents an historical view of past events; that is, of the manner in which selected ones of the constituent operations of the business process P executed in the past. Note that although the process flow diagram of FIG. 5 shows a great deal of information, it does not provide a detailed picture of the manner in which each of the selected constituent operations of P executed. For example, while the process flow diagram of FIG. 5 shows that A2 was executed after A1 and that A6 was executed after A1, it does not show that A2 followed A1 two thirds of the time and that A6 followed A1 the remaining one third of the time, or the details of any individual iteration P1, P2 or P3 of the execution of the business process P. The description below shows how such information may be represented in the generated process flow diagram, according to further embodiments of the present invention. Suffice it to say that the generated process flow diagram may be configured with as little or as much information as desired, with the means of doing so being limited only by the ingenuity of the implementation. Moreover, a suitable user interface may allow the user to dynamically change the appearance of the generated process flow diagram to show or emphasize different aspects, characteristics and parameters of the execution of the business process of interest to the user. As the data needed to generate such process flow diagrams is historical in nature, further manipulating it after the fact (that is, after the execution of the business process P) does not negatively impact the processing time expended to carry out the underlying process. In fact, the processing penalty incurred at runtime by implementing embodiments of the present invention may only include the cost of updating a counter upon execution of each selected constituent operation.

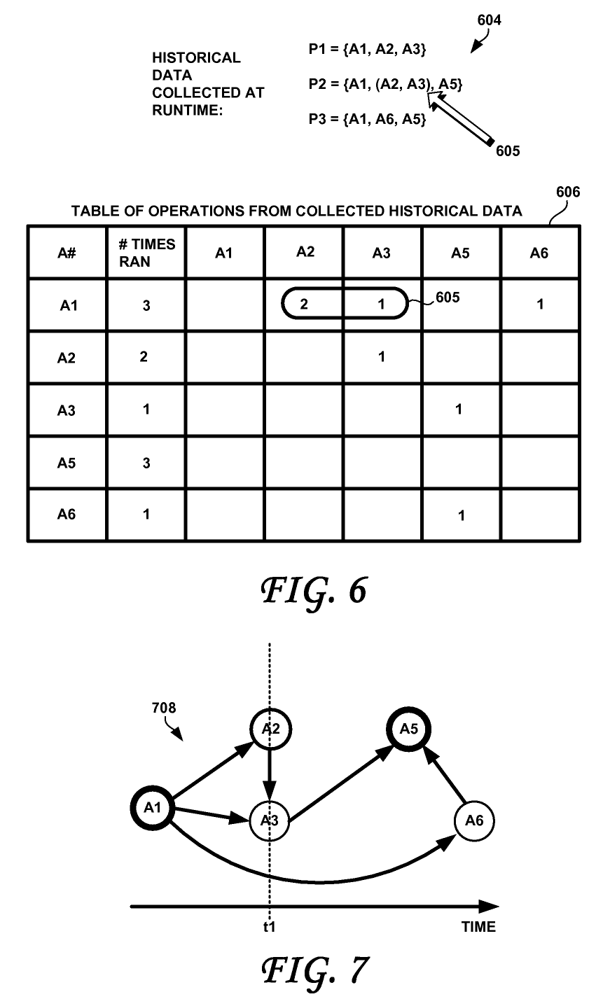

FIG. 6 shows an aggregation of historical data 604 collected at runtime for another iteration of business process P, as well as a table of operations 606 for such historical data, according to another embodiment of the present invention. FIG. 7 shows a process flow diagram 708 generated from the historical data in the table of operations of FIG. 6, according to another embodiment of the present invention. As shown therein, the historical data 604 reveals that iterations P1, P2 and P3 are identical to those shown in FIG. 4, but for the execution of selected operations A2 and A4 in iteration P2 of business process P. Therein, the parentheses around A2 and A3 at 605 are intended to convey that A2 and A3 executed at least partially concurrently. That is, they executed at the same time, their respective executions were initiated at the same time or their respective executions overlapped one another at least partially. For simplicity here, the assumption is that operations A2 and A3 executed at least partially concurrently. This concurrency is shown in the table of operations by the oval shape surrounding selected constituent operations A2 and A3, also denoted by reference number 605. The post-priori process flow diagram 708 that was generated and rendered from the historical data 604 of FIG. 6 is similar to that shown in FIG. 5, but for the A2 and A3 notes being aligned with one another, at time t1. In this manner, the generated and rendered process flow diagram can show selected constituent operations that were executed at the same time (in the past) t1, as well as those operations that follow each other consecutively.

As shown in FIG. 6, the table of operations may include a column that details the number of times each constituent operation was executed: A1 three times, A2 twice, A3 once, A5 three times and A6 once. This data may also be represented in the rendered process flow diagram 708. In this exemplary process flow diagram, the frequency of execution of each of the nodes of the diagram is illustrated by relatively thicker and thinner lines around each node. That is, operations A1 and A5 are shown with the thickest of lines, as these operations were carried out in each of the iterations P1, P2 and P3. Operation A2 is shown with an intermediate weight line, as it is executed twice and A3 and A6 with the thinnest line weight, as each is executed only once in the three iterations P1, P2 and P3 of the underlying business process P. Other way of conveying that information will undoubtedly occur to those of skill. For example, each node may include a simple notation that either states the whole number of times (e.g., 3×, 2× or 1×) that the operation was executed or that relates the same information in percentage form (e.g., (number of iterations/number of times operation was executed)×100). Such information may be very useful, in that it may guide the allocation of resources. For example, in deciding where to allocate scarce resources (e.g., time, personnel, money) to increase the yield of a given process, it is useful to know which of the constituent operations of a given business process are the most frequently executed, especially when such information is not known or knowable a priori. In the example developed in FIGS. 6 and 7, a judicious allocation of resources, all other parameters being equal, would be to strive to improve the performance of at least steps A1, A2 and A3, as these are the most frequently executed ones of the constituent operations of business process P.

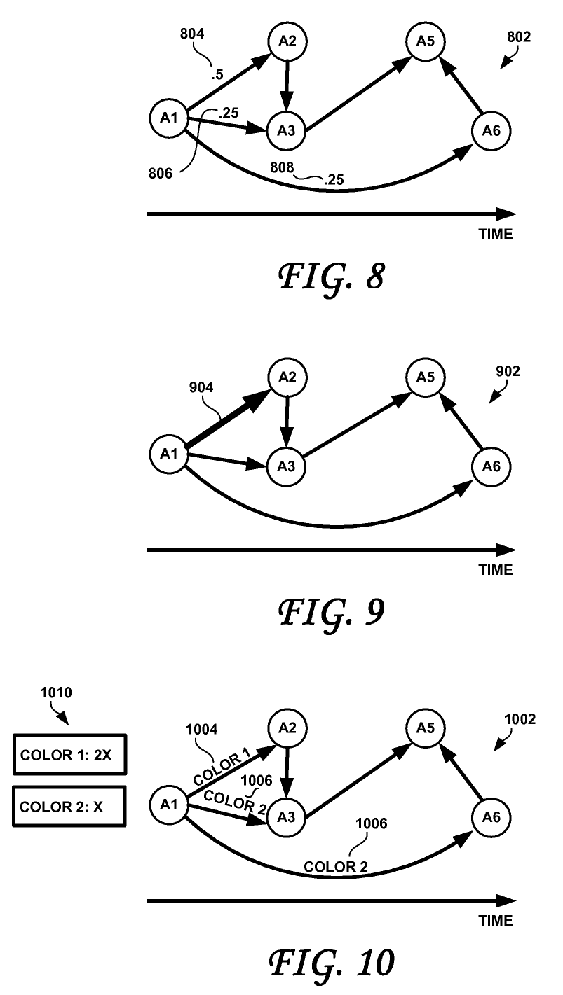

As foreshadowed above, a process flow diagram generated according to an embodiment of the present invention may include as much or as little information as needed or as deemed useful by the user. Moreover, there are no limits as to the manner in which such information may be presented to the user. FIGS. 8-12 show but a few representative examples of the different types of information that may be represented in a process flow diagram generated and rendered according to embodiments of the present invention. For example, FIG. 8 shows a process flow diagram 802 generated from the historical data in the table of operations of FIG. 6, according to yet another embodiment of the present invention. As shown therein, the process flow diagram 802 includes the numerical edge probability, i.e., visual indicia as to the frequency that a given selected constituent operation follows another of the selected constituent operations. In the exemplary case of FIG. 8, the generated and rendered process flow diagram 802 includes statistics 804 and 806 that give the user a statistical indication of the frequency of predecessor operations. As shown, selected constituent operation A2 followed A1 50% (one half) of the time, selected constituent operation A3 followed A1 25% (one quarter) of the time, and selected constituent operation A6 followed A1 25% of the time (the remaining one quarter of the time). As each of the selected constituent operation A2, A3, A5 and A6 have only a single edge or directed arc emanating therefrom, no numerical indicia is needed. Alternatively, but at the risk of cluttering the process flow diagram, a “1” may be placed next to each of the remaining edges; namely, between A2 and A3, between A3 and A5 and between A6 and A5.

Rather than utilizing numerical indicia to indicate frequency, other visual indicia may be used. For example, relative edge probabilities may be shown using, for example, thin and thick lines to convey higher and lower execution frequencies, respectively. For example, the relatively thicker edge 904 joining A1 and A2 in the process flow diagram 902 of FIG. 9 may give the user an intuitive feel that A2 follows A1 more often than does A3 or A6. Alternatively still, the aspects of FIGS. 8 and 9 may be combined such that the thicker edge 904 and the numerical indicia 904, 806 appear on the same process flow diagram. Colors may also be used to give an indication of frequency, as shown in the process flow diagram 1002 of FIG. 10. As shown therein, the directed arcs that join selected constituent operations may be represented in different colors to show that A2 follows A1 twice as often as does A3 and A6. For example, a first color 1004 “Color 1” may be used for the edge joining A2 and A1 and a second color 1006 “Color 2” may be used for the edge joining A3 to A1 and for the edge joining A6 and A1. A suitable legend 1010 may be provided to help the user interpret the intended meaning of the colors of the edges.

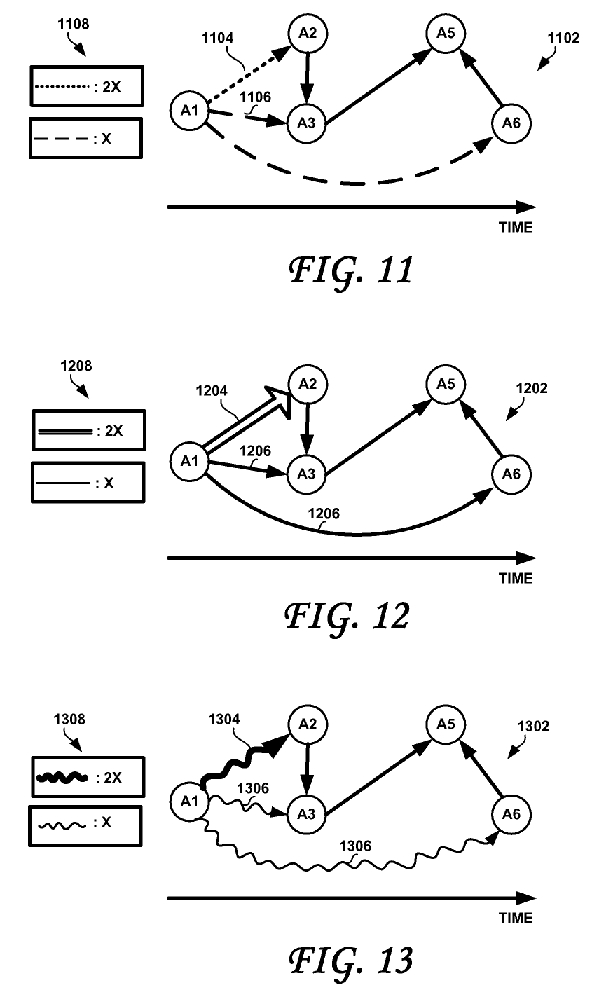

Similarly, different line types may be used as an indicator of the frequency that one selected constituent operation is a predecessor to another selected constituent operation, as shown in FIG. 11. As shown therein, the process flow diagram 1102 shows that operation A2 is joined to A1 via a dashed line edge 1104, whereas operation A3 is joined to A1 by a differently dashed line edge 1106, as is A6 to A1. A suitable legend 1108 may also be generated, to indicate the relative frequencies of the different line types used in the process flow diagram 1102. As shown in the process flow diagram 1202 of FIG. 12, still other line types may be used to indicate relative frequencies of node traversal, as shown at 1204 and 1206. Again, a legend 1208 may be generated, as an aid in interpreting the rendered process flow diagram. FIG. 13 shows a still further line types, in that a thick wavy line is used to represent a more frequently used edge 1304 and thin wavy lines 1306 is used to represent less frequently traversed edges. A legend 1308 may be provided to give the user additional information relative to the line types used in the process flow diagram 1302. As may be apparent from a collective consideration of the figures, many different types of visual indicia may be used, singly or in combination, to represent the historical statistical data gathered from the repeated execution of the business processes.

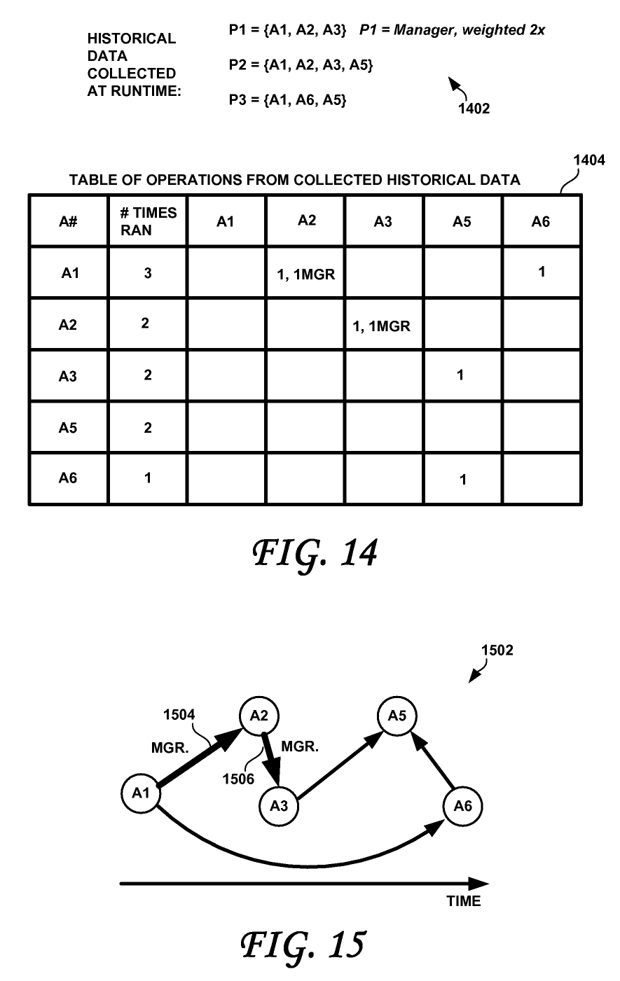

FIGS. 14 and 15 illustrate another embodiment of the present invention. Therein, the concept of priority processes is introduced. The concept of priority processes is predicated upon the precept that constituent operations of business processes performed by a given entity, by a person or process having a predetermined role or priority, at a certain time, in a certain place and/or under predefined conditions may be considered to be more representative than others, more important than others or otherwise more significant than others. In the exemplary business process shown in FIG. 14, the iteration P1 of the business process was performed by a manager. In this example and for whatever reason, all iterations of the business process that were performed by, initiated by or on behalf of managers or equivalent role are weighed higher (e.g., twice as high) as iterations performed by, initiated by or on behalf of others. That the manager performed the iteration P1 of the business process P is also annotated in the table of operations 1404 corresponding to the collected historical data 1402. In this table of operations 1404, the notation 1, 1MGR that appears twice therein indicates that selected constituent operation A2 was preceded by A1 once by a non manager and once by a manager, and that selected constituent operation A3 was preceded by operation A2 once by a non-manager and once by a manager. The path through the constituent operations may be highlighted in the generated and rendered process flow diagram 1502 of FIG. 15. In the process flow diagram 1502, the path representing the iteration P1 through the nodes is shown as relatively thicker edges, to indicate a heightened weight or importance to be attributed thereto. Indeed, the iteration P1 may be considered or interpreted as being more representative than other iterations P2 and P3 and may, for example, be assigned a predefined higher weight (e.g., 2×). This relatively higher weight or importance may be shown in the rendered process flow diagram in any way that is meaningful to the user, as FIGS. 7-13 attest. Alternatively, a lower weight may be assigned may be assigned for some execution iterations of the business process P, for any reason.

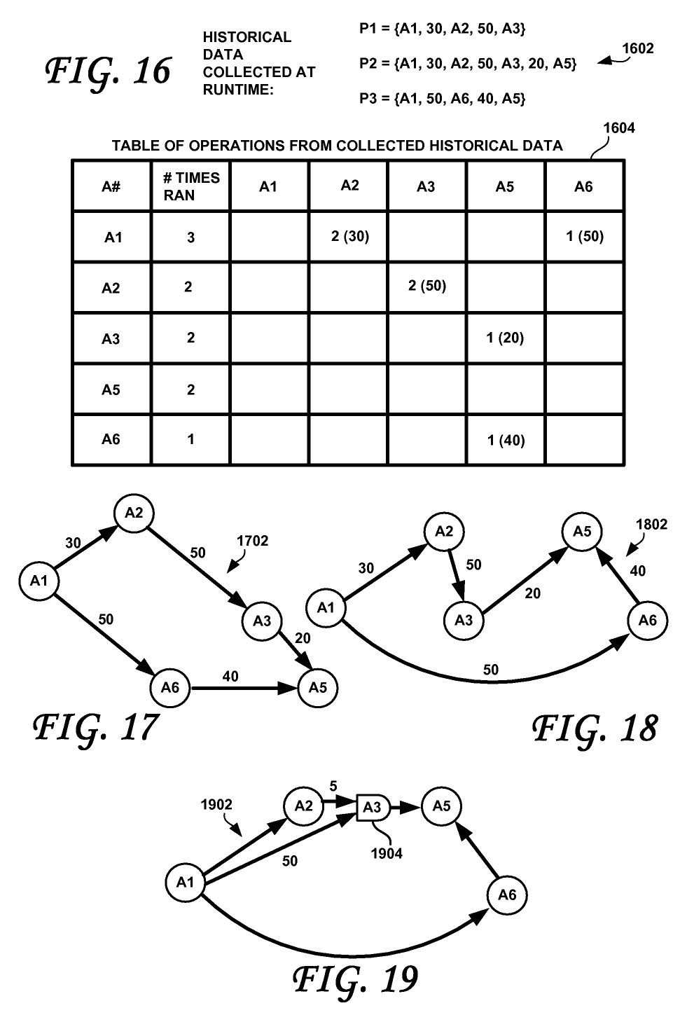

FIG. 16 shows another iteration of an exemplary business process P. In this case, in addition to collecting, storing and compiling data relative to which of the constituent operations were executed and in what order, an embodiment of the present invention envisages to also collect data indicative of the elapsed time between the execution of the constituent operations of each of the iterations P1, P2 and P3 of the business process P 1602. This information may then be used to identify and correct potential bottlenecks in the flow of the business process. In addition, other time-related measures can also be tracked and displayed in a process flow diagram, such as the average time to completion of each of the constituent operations and of the iteration as a whole. As shown at 1602, the historical data collected, in this illustrative example, includes the time elapsed between consecutively executed operations. As shown, 30 time units (e.g., msec, seconds, minutes, hours, days, etc.) elapsed between the time operation A1 was triggered and executed and the time that operation A2 was triggered and executed. This information was also collected and included in the table of operations 1604, as shown in parenthesis. Therefore, from the table of operations 1604, it may be seen that operation A2 followed operation A1 after an average elapsed time of 30 and that A3 was triggered and executed 50 time units after A2 was triggered and executed. The time-related information may be easily gathered at runtime without a too onerous performance penalty using, for example, a counter that counts up or down between consecutive executions of selected operations within an iteration. Alternatively, reference may be made to a clock to obtain the same information (i.e., elapsed time).

The process flow diagram may be configured to convey the collected historical time information. One possible implementation of a process flow diagram that shows such time-related information is shown at 1702 in FIG. 17. As shown therein, the process flow diagram 1702 may represent the time elapsed between consecutively executed selected operations by the length of the connection edges between the operations. In FIG. 17, a longer edge between operations indicates a longer elapsed time between executions thereof. For example, the edge between A2 and A3 is longer than the edge between A3 and A5, as 50 time units elapsed between the triggering and execution of A3 and A2, whereas the historical data indicates that A5 followed A3 after only 20 time units elapsed. The actual time delay (if only one instance of a given pair of operations were consecutively executed, such as (A2, A3)) or average time delay (if more than one instance of a given pair of operations were consecutively executed—such as (A1, A2) and (A2, A3)) may also be rendered (e.g., by showing the numbers 50, 40, 30 or 20 next to the edges between operations). As shown in the process flow diagram 1802 of FIG. 18, the length of the edges shown in the process flow diagram may be arbitrary, and the time elapsed between consecutively triggered and executed operations may be shown numerically. Those of skill in this art may devise other embodiments that collect, store and compile parameters other than shown and discussed herein and all such embodiments are considered to fall within the scope of the claims appended hereafter.

For example, the collected historical statistical data may be examined and certain nodes may be determined to be statistical AND nodes or may be determined to be statistical OR nodes. If a node executes most of the time (say, a predetermined but user-selectable percentage of the time, e.g., 90%) only after two or more of its predecessor nodes have executed, the node may be considered to be a statistical AND node, meaning that it effectively blocks further processing until all of its incoming edges have been traversed. Note that the predetermined percentage of 90% allows for the case in which fully 10% of the time, the destination operation is triggered and executed without all of its incoming edges having been traversed. FIG. 19 shows an exemplary process flow diagram 1902 showing such an ANDing node A3 at 1904. In this process flow diagram, the node corresponding to operation A3 has been determined to be a statistical AND node, as it has been determined that A3 did not trigger and execute until both its predecessor operations A2 and A1 have finished executing and the process flow has reached A3. Note that this is also a statistical measure based on historical data, in contrast to the rigid AND/OR nodes in traditional workflows. In the process flow diagram 1902, the statistical ANDing node 1904 is represented with a traditional AND gate familiar to digital designers. A numerical indicia such as, for example, “90%” may be rendered next to the ANDing node 1904, indicating that the node behaves like an AND gate 90% of the time, implying that it behaves as an OR gate the remaining 10% of the time. However, the statistical ANDing nature of such a node may be indicated in process flow diagrams in any other manner, including simply labeling the node with an “AND” label. This alerts the user that only when both incoming edges have been traversed will a statistical AND node be triggered and executed. For example, if one edge leading to a statistical ANDing node is 5 units long (meaning that the time elapsed between its origination and destination nodes is 5 units long) and if another edge leading to the statistical ANDing node is 50 units long (as shown in FIG. 19), the statistical ANDing nature of operation A3 is such that operation A3 will not trigger and execute at least until the time delay of its longest edge has elapsed—in this case, at least 50 time units after operation A1 has triggered and executed. This may help the user to diagnose potential bottlenecks in the process.

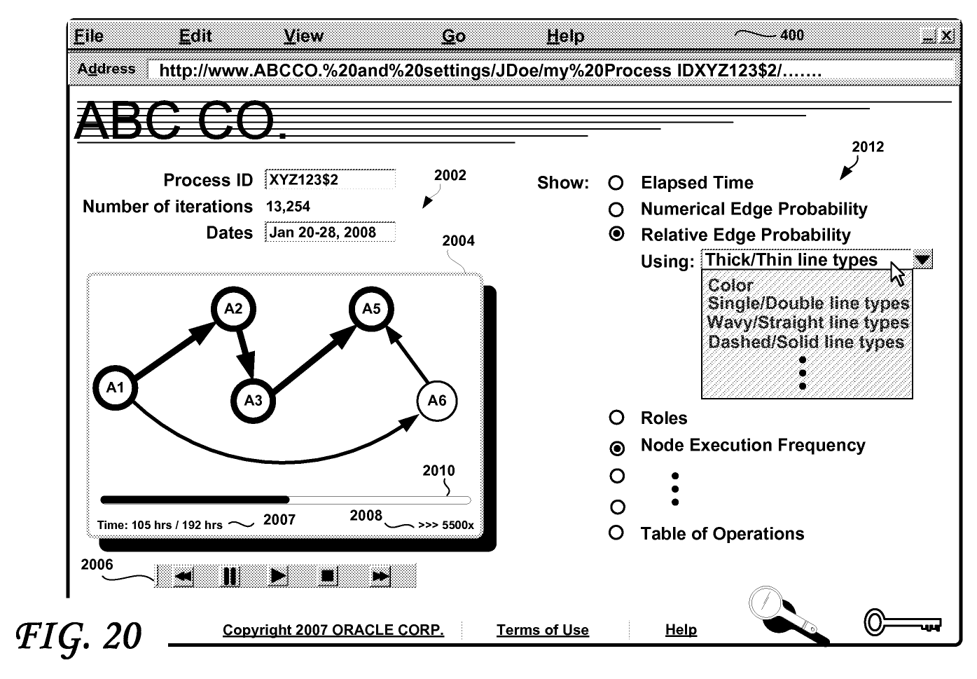

Embodiments of the present invention may utilize a web browser to implement a user interface that enables the user to control various aspects of the generated process flow diagram. An exemplary layout for such a user interface (UI) is shown in FIG. 20. It is to be understood that the layout of FIG. 20 is only exemplary in nature and that embodiments of the present invention may be carried out with user interfaces that bear no resemblance to that shown in FIG. 20. The UI may provide the user with a mechanism, shown at 2002, for entering an identifier for the business process whose execution flow over time is to be diagrammed. In this exemplary and illustrative case, the user has entered a process ID of XYZ123$2 for the identifier of the business process to be diagrammed. The user may also enter a predetermined time over which the execution iterations of the business process of interest are to be diagrammed. In this case, the user has entered Jan. 20-28, 2008. Therefore, the process flow diagram to be generated will show a process flow diagram representation of the historical data collected from the execution iterations of business process whose identifier is XYZ123$2 over a date range spanning from Jan. 20, 2008 to Jan. 28, 2008.

Such a process flow diagram is shown at 2004. Again, the process flow diagram generated and rendered in the browser of FIG. 20 need not be of the type including nodes and edges configured as directed arcs, and any other representation of the historical data is deemed to fall within the purview of the claimed embodiments of the present inventions. The user, as shown at 2012, may also be given the opportunity to select one or more characteristics of the rendered process flow diagram. For example, the UI may be provided with, e.g., radio buttons, pull down menus and the like that enable the user to change the appearance of the rendered process flow diagram and/or the information displayed therein. This may be done to alter the appearance of the process flow diagram and/or to cause the rendered process flow diagram to display a greater or a lesser number of characteristics. For example, the user may select “Elapsed Time”, to cause the rendered process flow diagram to display the elapsed time between consecutively triggered and executed constituent operations (represented in the process flow diagram as nodes), in the manner or in a manner similar to that shown in FIGS. 16-18—if such data was collected upon execution of the business process during the time span selected. Similarly, the UI may provide the user with the ability to include numerical edge probabilities, such as shown in FIG. 8 and/or relative edge probabilities, as shown in FIGS. 9-13. Note that, in the exemplary and illustrative case of FIG. 20, the “Relative Edge Probability” radio button has been selected, and that the rendered process flow diagram is rendered with relatively thicker edges or directed arcs between the constituent operations A1, A2, A3 and A5, indicating that the flow A1, A2, A3, A5 was more commonly executed than the A1, A6, A5 flow, which is shown with relatively thinner edges or directed arcs. A pull down menu or other known UI device may be provided to allow the user to choose how such relative edge probabilities are to be shown in the rendered process flow diagram 2004. For example, the pull down menu 2012 shown in FIG. 20 may allow the user to select color (as shown in FIG. 10), single/double lines (FIG. 12), wavy/straight lines (FIG. 13), dashed/solid lines (FIG. 11) to represent the relative edge probabilities in the rendered process flow diagram. It is to be understood that other graphic devices and/or other perceptible indicia may be used to convey relative edge probabilities (or any other characteristic that may be mined from the collected historical data), and that all such graphic devices or perceptible indicia may be selectable by the user via the UI. A radio button or other UI device may also be provide to allow the user to cause the roles (e.g., Manager, see FIGS. 14 and 15 and corresponding described herein above) to be displayed on the rendered process flow diagram. In the exemplary UI of FIG. 20, the user has selected “Node Execution Frequency”, to cause the rendered process flow diagram to show indicia of which nodes were the most frequently traversed in the iterations of the business process whose execution is being diagrammed. Therefore, the process flow diagram shows the most traversed nodes in bold; namely, A1, A2, A3 and A5. Other dimensions of the collected historical data may selected by the user and shown in the process flow diagram 2004, and the UI may provide the user with appropriate onscreen mechanisms to do so, as suggested by the “ . . . ” below the “Node Execution Frequency” radio button in FIG. 20.

As noted above, the historical data corresponds to data collected contemporaneously with the execution of the constituent operations of the business process under investigation, the historical data being collected over a user-selectable period of time. Therefore, taken in the aggregate, the historical data may be used to show a static view of the execution iterations of the business process in question. However, the historical data may also be stepped through in a linear accelerated or decelerated fashion, thereby affording the user a dynamic, albeit historical, view of the collected data. In the illustrative example of FIG. 20, the period of time selected by the user spans eight days, from Jan. 20-28, 2008—or 192 hours, as shown at reference numeral 2007. Therefore, the rendering of the process flow diagram may be readily controlled to render the historical data in a linear manner, starting with the data collected on Jan. 20, 2008 and stepping sequentially through the historical data collected that day, and only then rendering the data collected on Jan. 21, 2008, and so on. What results is a dynamic view of the execution iterations of the business process under investigation, potentially showing changing edge probabilities and/or other characteristics over time. The dynamic process flow diagram may be controlled such that the changes in the process flow diagram are rendered at the same rate at which they were collected. However, such rate is unlikely to be convenient for the user. Therefore, the UI may provide the user with the ability to speed up or slow down the rate at which the historical data is rendered; that is, the rate at which the historical data is stepped through and rendered in the process flow diagram. In FIG. 20, the rate at which the rendering is carried out has been accelerated about 5500 times, as indicated at 2008, compressing the eight day date range entered by the user into about two minutes. Therefore, the process flow diagram may be observed by the user to evolve over a period of two minutes. For example, a scrollbar 2010, familiar to users of Personal Video Recorders (PVR), may be provided, to show the progress of the rendering over the entered date range. Video-like controls 2006 may also be provided, to allow the user to fast forward, rewind, pause or stop the playback and dynamic rendering of the process flow diagram.

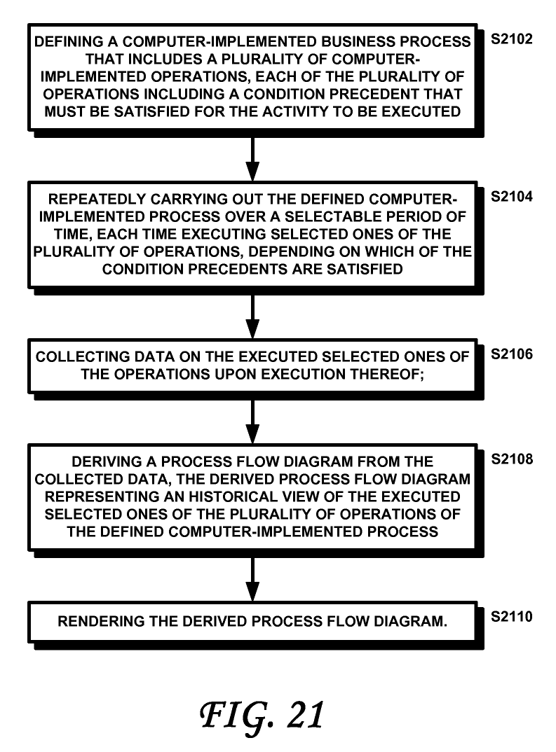

FIG. 21 is a flowchart of an embodiment of a computer-implemented method for deriving a process flow diagram, according to an embodiment of the present invention. As shown, the computer-implemented method may include a step S2102 of defining a computer-implemented business process that includes a plurality of computer-implemented operations. Each of these operations may be configured to including a condition precedent that must be satisfied for the activity to be executed. For example, the condition precedent may be the execution of another operation and/or the occurrence of a predetermined event. Step S2104 calls for repeatedly carrying out the defined computer-implemented process over a selectable period of time, each time executing selected ones of the plurality of operations, depending on which of the condition precedents are satisfied. The selected ones of the plurality of operations may include all or only some of the constituent operations of the defined business process. Step S2106 includes collecting data on the executed selected ones of the operations upon execution thereof. That is, the data may be collected contemporaneously with the execution of the selected operations. As shown step S2108 includes deriving a process flow diagram from the collected data. As described above, the derived process flow diagram represents an historical view of the executed selected ones of the plurality of operations of the defined computer-implemented process. Lastly, step S2110 calls for rendering the derived process flow diagram, as shown in the figures discussed above.

The data collected contemporaneously with the execution of the selected constituent operations of the business process may include, for example, an identifier of the executed selected operation, a total number of edges coming into each of the executed selected operations (i.e., the total number of operations that feed into the executed selected operation) and the number of times a next executed selected operation is triggered after execution of the current node, an identifier of the predecessor selected operation that was executed, and a number of times each selected operation was executed. Other data that may be collected may include, for example, a role of the person, process or entity that caused the execution of the execution iteration of the business process (e.g., manager), the time elapsed between sequentially executed selected operations, and time and date at which the selected operations executed, to name but a few of the different types of data that may be collected, stored and compiled into the historical data that is to form the basis of a later generated and rendered process flow diagram.

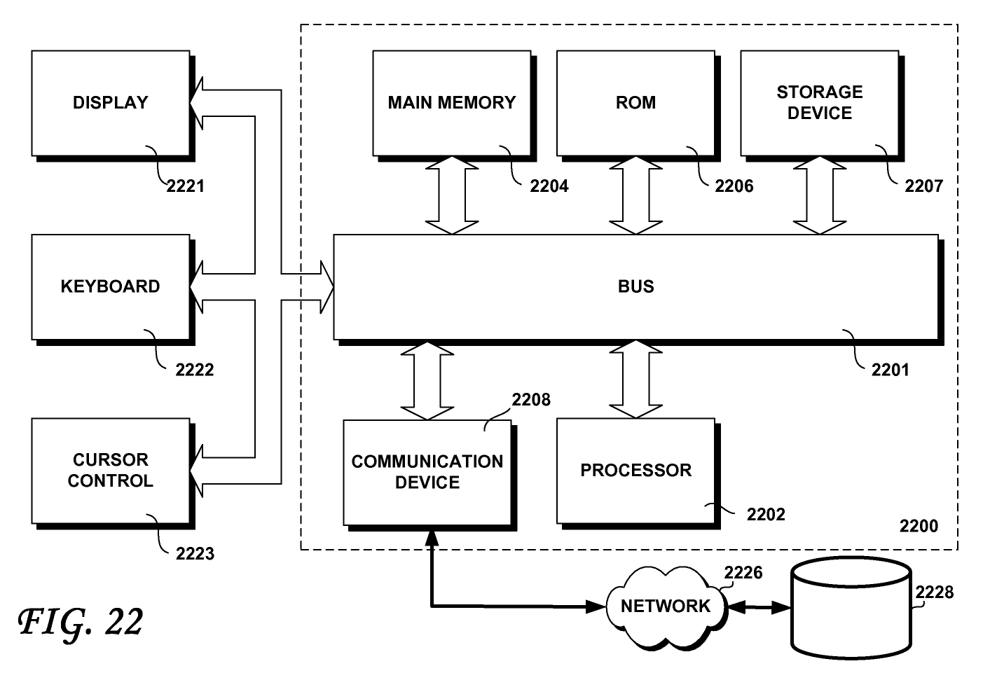

FIG. 22 illustrates a block diagram of a computer system 2200 upon which embodiments of the present inventions may be implemented. Computer system 2200 may include a bus 2201 or other communication mechanism for communicating information, and one or more processors 2202 coupled with bus 2201 for processing information. Computer system 2200 further comprises a random access memory (RAM) or other dynamic storage device 2204 (referred to as main memory), coupled to bus 2201 for storing information and instructions to be executed by processor(s) 2202. Main memory 2204 also may be used for storing temporary variables or other intermediate information during execution of instructions by processor 2202. Computer system 2200 also may include a read only memory (ROM) and/or other static storage device 2206 coupled to bus 2201 for storing static information and instructions for processor 2202. A data storage device 2207, such as a magnetic disk or optical disk, may be coupled to bus 2201 for storing information and instructions. The computer system 2200 may also be coupled via the bus 2201 to a display device 2221 for displaying information to a computer user. An alphanumeric input device 2222, including alphanumeric and other keys, may be coupled to bus 2201 for communicating information and command selections to processor(s) 2202. Another type of user input device is cursor control 2223, such as a mouse, a trackball, or cursor direction keys for communicating direction information and command selections to processor 2202 and for controlling cursor movement on display 2221. The computer system 2200 may be coupled, via a communication device (e.g., modem, network interface card) coupled to a network 2224 and to a database 2226 configured to store, e.g., the historical information related to the executions of the selected business process, according to embodiments of the present invention.

Embodiments of the present invention are related to the use of computer system and/or to a plurality of such computer systems to derive process flow diagrams. According to one embodiment, the methods and systems described herein may be provided by one or more computer systems 2200 in response to processor(s) 2202 executing sequences of instructions contained in memory 2204. Such instructions may be read into memory 2204 from another computer-readable medium, such as data storage device 2207. Execution of the sequences of instructions contained in memory 2204 causes processor(s) 2202 to perform the steps and have the functionality described herein. In alternative embodiments, hard-wired circuitry may be used in place of or in combination with software instructions to implement the present invention. Thus, the present invention is not limited to any specific combination of hardware circuitry and software. Indeed, it should be understood by those skilled in the art that any suitable computer system may implement the functionality described herein. The computer system may include one or a plurality of microprocessors working to perform the desired functions. In one embodiment, the instructions executed by the microprocessor or microprocessors are operable to cause the microprocessor(s) to perform the steps described herein. The instructions may be stored in any computer-readable medium. In one embodiment, they may be stored on a non-volatile semiconductor memory external to the microprocessor, or integrated with the microprocessor. In another embodiment, the instructions may be stored on a disk and read into a volatile semiconductor memory before execution by the microprocessor.

While the foregoing detailed description has described preferred embodiments of the present invention, it is to be understood that the above description is illustrative only and not limiting of the disclosed invention. Those of skill in this art will recognize other alternative embodiments and all such embodiments are deemed to fall within the scope of the present invention. Thus, the present invention should be limited only by the claims as set forth below.

What is claimed is:

1. A computer-implemented method of deriving a process flow diagram, comprising the steps of:
defining a computer-implemented business process, the business process including a plurality of computer-implemented operations, each of the plurality of operations including a condition precedent that must be satisfied for the activity to be executed;
repeatedly carrying out the defined computer-implemented process over a selectable period of time, each time executing selected ones of the plurality of operations, depending on which of the condition precedents are satisfied;
collecting data on the executed selected ones of the operations upon execution thereof
deriving the process flow diagram from the collected data, the derived process flow diagram representing an historical view of the executed selected ones of the plurality of operations of the defined computer-implemented process, and rendering the derived process flow diagram.

2. The computer-implemented method of claim 1, wherein the collecting step is carried out over a first predetermined period of time and wherein the deriving step is carried out from the data collected during the predetermined period of time.

3. The computer-implemented method of claim 1, wherein the collecting step is carried out over a second predetermined period of time that is longer than the first predetermined period of time, and wherein the deriving step includes a step of modifying the process flow diagram derived from the statistics collected during the first predetermined time period to reflect the data collected over the second predetermined period of time.

4. The computer-implemented method of claim 1, further including a step of generating an ordered list of the executed selected ones of the plurality of operations each time the computer-implemented process is carried out and wherein the data collecting step is carried out on the generated ordered list generated for each iteration.

5. The computer-implemented method of claim 1, wherein the data collecting step collects data indicative of a time elapsed between execution of a previously executed selected activity and execution of a next executed selected activity and wherein the deriving and rendering step are carried out such that the process flow diagram includes indicia indicative of the elapsed time.

6. The computer-implemented method of claim 1, wherein the data collecting step includes collecting data indicative of whether any two or more of the executed selected operations executed at least partially concurrently and wherein the deriving and rendering steps are carried out such that the process flow diagram indicates any concurrency of execution of the executed selected operations.

7. The computer-implemented method of claim 1, wherein the statistics collecting step includes a step of collecting data that includes an identification of each of the executed selected operations and wherein the deriving and rendering steps are carried out such that the process flow diagram includes indicia of the identification of at least one executed selected operation.

8. The computer-implemented method of claim 7, wherein the generating step includes generating a node in the process flow diagram for each of the executed selected operations.

9. The computer-implemented method of claim 8, wherein the generating step includes joining the generated nodes with a directed arc that indicates an order of execution of the executed selected operations corresponding to the generated nodes.

10. The computer-implemented method of claim 2, further including a step of providing a user interface to enable a user to manipulate the rendered process flow diagram according to what data was collected in the collecting step.

11. The computer-implemented method of claim 1, wherein the deriving and rendering steps are carried out such that the process flow diagram includes probability indicia indicative of a frequency of traversal of at least selected portions of the process flow diagram.

12. The computer-implemented method of claim 10, wherein the providing step is carried out such that the user interface provides a user with the ability to render the process flow diagram dynamically over the first predetermined period of time.

13. The computer-implemented method of claim 12, wherein the providing step is carried out such that the user interface provides the user with video-like controls to control a rate at which the process flow diagram renders the collected data.

14. The computer-implemented method of claim 1, wherein the deriving and rendering steps are carried out such that the process flow diagram includes indicia indicative of a role of a person or entity that executed one or more iterations of the computer-implemented process.

15. The computer-implemented method of claim 1, further including assigning a weight to a predetermined execution of the computer-implemented process and wherein the deriving and rendering steps are carried out such that the process flow diagram includes indicia indicative of the assigned weight.

16. The computer-implemented method of claim 1, wherein the deriving and rendering steps are carried out such that the process flow diagrams includes an identification of any executed selected ones of the plurality of operations that are determined to be statistical AND nodes.

17. The computer-implemented method of claim 1, wherein the deriving and rendering steps are carried out such that the process flow diagrams includes an identification of any executed selected ones of the plurality of operations that are determined to be statistical OR nodes.

18. A computer system for deriving a process flow diagram, the computer system comprising:
at least one processor;
at least one data storage device coupled to the at least one processor;
a plurality of processes spawned by said at least one processor, the processes including processing logic for:
defining a computer-implemented business process, the business process including a plurality of computer-implemented operations, each of the plurality of operations including a condition precedent that must be satisfied for the activity to be executed;
repeatedly carrying out the defined computer-implemented process over a selectable period of time, each time executing selected ones of the plurality of operations, depending on which of the condition precedents are satisfied;
collecting data on the executed selected ones of the operations upon execution thereof,
deriving the process flow diagram from the collected data, the derived process flow diagram representing an historical view of the executed selected ones of the plurality of operations of the defined computer-implemented process, and
rendering the derived process flow diagram.

19. A machine-readable medium having data stored thereon representing sequences of instructions which, when executed by a computing device, causes the computing device to derive a process flow diagram, by performing the steps of:
defining a computer-implemented business process, the business process including a plurality of computer-implemented operations, each of the plurality of operations including a condition precedent that must be satisfied for the activity to be executed;
repeatedly carrying out the defined computer-implemented process over a selectable period of time, each time executing selected ones of the plurality of operations, depending on which of the condition precedents are satisfied;
collecting data on the executed selected ones of the operations upon execution thereof;
deriving the process flow diagram from the collected data, the derived process flow diagram representing an historical view of the executed selected ones of the plurality of operations of the defined computer-implemented process, and
rendering the derived process flow diagram.
